(19) United States
(12) Patent Application Publication
(10) Pub. No.: US 2011/0311264 A1
(43) Pub. Date: Dec. 22, 2011

(54) IMAGE FORMING APPARATUS

(75) Inventor: Mitsuhisa Kato, Shizuoka-ken (JP)

(73) Assignees: TOSHIBA TEC KABUSHIKI KAISHA, Tokyo (JP); KABUSHIKI KAISHA TOSHIBA, Tokyo (JP)

(21) Appl. No.: 13/161,653

(22) Filed: Jun. 16, 2011

Related U.S. Application Data
(60) Provisional application No. 61/356,888, filed on Jun. 21, 2010.

(51) Int. Cl. G03G 21/00; G03G 15/16; G03G 15/01

(52) U.S. Cl. 399/101; 399/346; 399/344

(57) ABSTRACT

According to one embodiment, an image forming apparatus includes a lubricant having a bar shape along the axial direction of a transfer roller, a brush roller which applies a component of the lubricant to the surface of the transfer roller, and a plurality of bases which are made of metal and are disposed at intervals along the axial direction of the transfer roller. The bases hold the lubricant in a state where the lubricant comes in contact with the brush roller.

### CROSS-REFERENCE TO RELATED APPLICATIONS

This application is based upon and claims the benefit of priority from U.S. Provisional Application No. 61/356,888, filed on Jun. 21, 2010, the entire contents of which are incorporated herein by reference.

### FIELD

Embodiments described herein relate generally to an image forming apparatus that cleans developer remaining on the surface of an image holding body using a blade.

### BACKGROUND

In an image forming apparatus that cleans developer remaining on the surface of an image holding body such as a photoconductive drum or a transfer belt using a contact of a blade, a lubricant is applied to the image holding body in order to protect the image holding body and the blade. As the lubricant, a metal soap is used.

Due to a change in ambient temperature, cracks may be generated in the metal soap.

### BRIEF DESCRIPTION OF THE DRAWINGS

FIG. 1 is a diagram showing the overall configuration according to an embodiment.

FIG. 2 is a diagram showing the configuration of the periphery of each photoconductive drum in FIG. 1.

FIG. 3 is a diagram showing the configuration of the periphery of a secondary transfer roller in FIG. 1.

FIG. 4 is a diagram showing the secondary transfer roller, a metal soap, a brush roller, bases, and springs in FIG. 3 in a side view.

FIG. 5 is a diagram showing an experimental result of the thermal expansion of the metal soap and the thermal expansion of the base in FIG. 3.

FIG. 6 is a diagram showing a secondary transfer roller, a metal soap, a brush roller, bases, and springs according to another embodiment in a side view.

### DETAILED DESCRIPTION

In general, according to one embodiment, an image forming apparatus includes: an image holding body on which a developer image is formed; a transfer roller which rotates while coming in contact with a surface of the image holding body, and rotates with a recording medium interposed between the image holding body and the transfer roller, thereby transferring the developer image on the image holding body onto the recording medium; a blade which cleans the developer remaining on the surface of the image holding body or the surface of the transfer roller by coming in contact with the surface of the image holding body or the surface of the transfer roller; a lubricant having a bar shape along the axial direction of the transfer roller; a brush roller which rotates while coming in contact with the transfer roller and the lubricant, thereby applying a component of the lubricant to the surface of the transfer roller; and a plurality of bases which are made of metal and are disposed at intervals along the axial direction of the transfer roller, the bases holding the lubricant in a state where the lubricant comes in contact with the brush roller.

Hereinafter, an embodiment will be described with reference to the accompanying drawings.

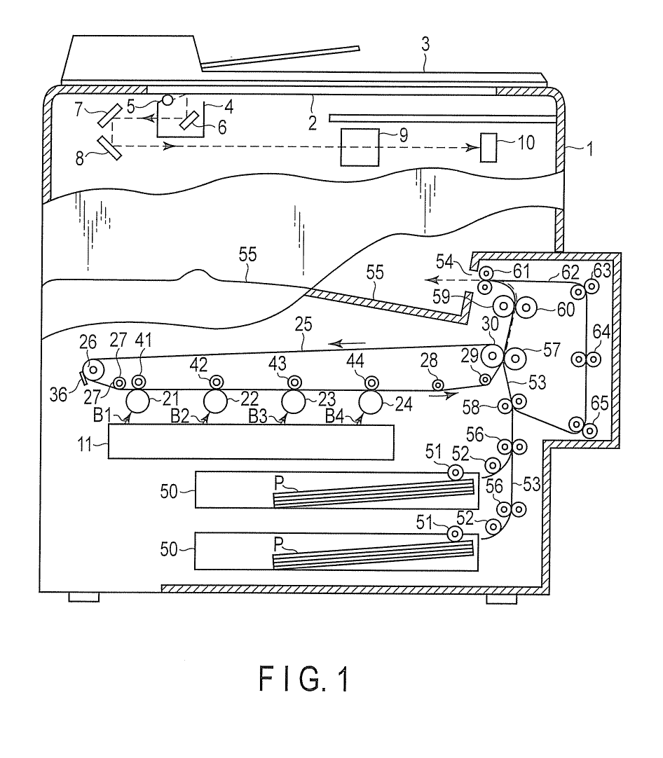

As shown in FIG. 1, at an upper portion of a main body 1 of an image forming apparatus, a transparent document table (glass plate) 2 on which original documents are placed is disposed. A cover 3 is disposed on the document table 2 to be opened and closed. A carriage 4 is disposed on a lower surface side of the document table 2. An exposure lamp 5 is disposed in the carriage 4. The carriage 4 is moved forward and backward along the lower surface of the document table 2. As the carriage 4 is moved forward, the exposure lamp 5 is lit, such that the original document on the document table 2 is exposed. Due to the exposure, a reflected light image of the original document on the document table 2 is obtained. The reflected light image is projected onto a CCD (Charge Coupled Device) 10 by reflective mirrors 6, 7, 8 and a variable power lens block 9. The CCD 10 outputs an image signal at a level corresponding to the projected reflected light image.

The image signal output from the CCD 10 is appropriately processed and then is supplied to an exposure unit 11. The exposure unit 11 emits a laser beam B1 in response to a yellow image signal, a laser beam B2 in response to a magenta image signal, a laser beam B3 in response to a cyan image signal, and a laser beam B4 in response to a black image signal toward photoconductive drums 21, 22, 23, and 24 which are image holding bodies, respectively. The photoconductive drum 21 is for forming a yellow image, the photoconductive drum 22 is for forming a magenta image, the photoconductive drum 23 is for forming a cyan image, and the photoconductive drum 24 is for forming a black image.

Above the photoconductive drums 21, 22, 23, and 24, a transfer belt 25 which is another image holding body is disposed. The transfer belt 25 is suspended on a drive roller 26, guide rollers 27, 28, and 29, and a driven roller 30 and rotates counterclockwise by receiving a driving force from the drive roller 26.

At positions opposing the photoconductive drums 21, 22, 23, and 24, primary transfer rollers 41, 42, 43, and 44 are respectively disposed. The primary transfer rollers 41, 42, 43, and 44 rotate the transfer belt 25 while causing the transfer belt 25 to come in pressing contact with the photoconductive drums 21, 22, 23, and 24, respectively, such that visible images (also referred to as developer images) on the photoconductive drums 21, 22, 23, and 24, which will be described later, are primarily transferred onto the transfer belt 25.

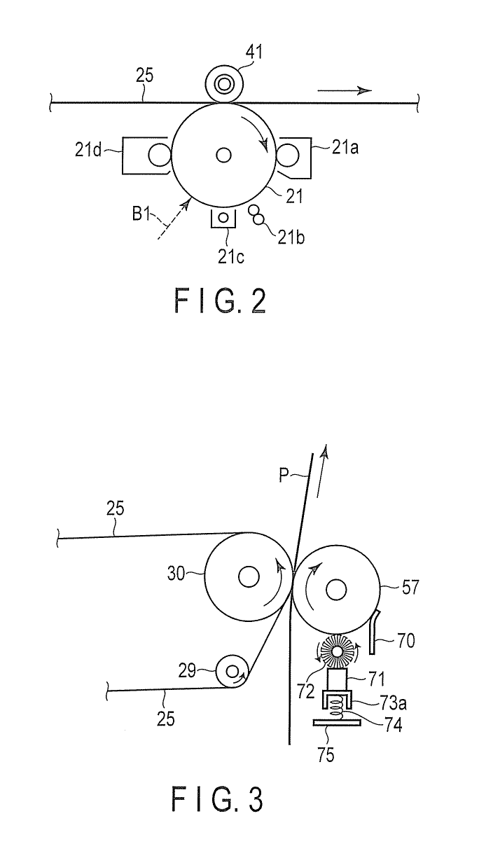

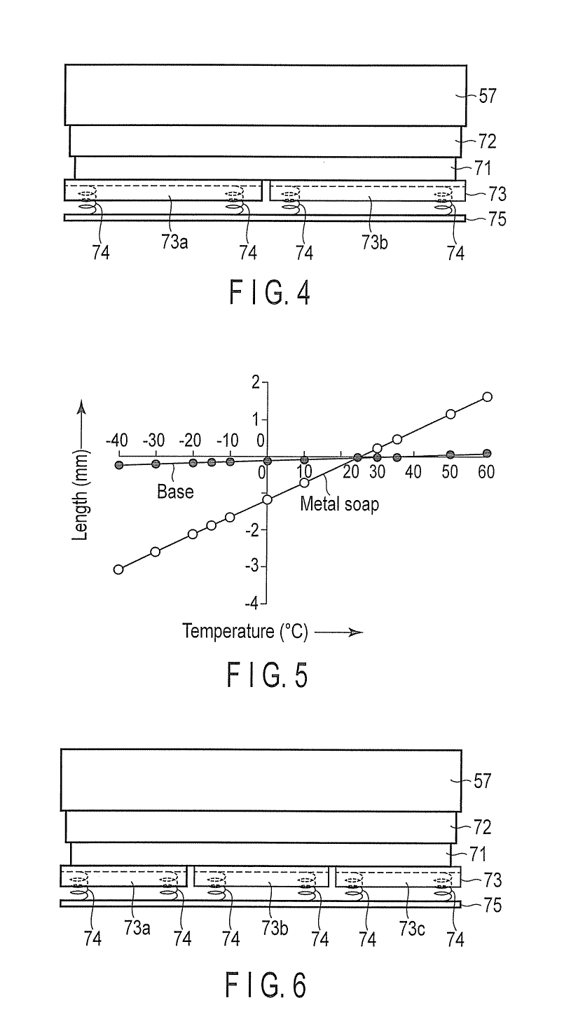

The configurations of the photoconductive drum 21 and surrounding units thereof are shown in FIG. 2. In the periphery of the photoconductive drum 21, a cleaner 21a, a neutralization lamp 21b, a charging unit 21c, and a yellow developing unit 21d are disposed. The cleaner 21a removes a developer remaining on the surface of the photoconductive drum 21. The neutralization lamp 21b removes charge remaining on the surface of the photoconductive drum 21. The charging unit 21c charges the surface of the photoconductive drum 21 with a static charge by applying a high voltage to the photoconductive drum 21. The surface of the photoconductive drum 21 with a static charges is illuminated with the laser beam B1 emitted from the exposure unit 11. Through the illumination, an electrostatic latent image is formed on the surface of the photoconductive drum 21. The developer 21d develops the electrostatic latent image on the surface of the photoconductive drum 21 into a yellow visible image by supplying the yellow developing material (toner) onto the surface of the photoconductive drum 21.

Other photoconductive drums 22, 23, and 24 and surrounding units thereof have the same configurations. Therefore, description thereof will be omitted.

Below the exposure unit 11, a plurality of paper feed cassettes 50 are disposed. The paper feed cassettes 50 store paper sheets P which are recording media. At positions opposing the paper feed cassettes 50, pick-up rollers 51 and paper feed rollers 52 are disposed. Each pick-up roller 51 takes out the paper sheets P one by one from the corresponding paper feed cassette 50. Each paper feed roller 52 sends the paper sheet P taken out by the corresponding pick-up roller 51 to a transport path 53. The transport path 53 extends upward to a paper discharge opening 54 via the position opposing the driven roller 30. The paper discharge opening 54 faces a paper discharge tray 55 extending to the outer peripheral surface of the main body 1.

In the vicinity of the each paper feed roller 52, corresponding transport rollers 56 are disposed. At the position opposing the driven roller 30 in the transport path 53, a secondary transfer roller 57 is disposed with the transfer belt 25 interposed therebetween. At a position in front of the secondary transfer roller 57 and the driven roller 30, a registration roller 58 is disposed. The secondary transfer roller 57 rotates while coming in contact with the surface of the transfer belt 25, and rotates with the paper sheet P interposed between the secondary transfer roller 57 and the transfer belt 25, such that the visible image (the developer image) on the transfer belt 25 is secondarily transferred onto the paper sheet P. A state where the paper sheet P passes between the transfer belt 25 and the secondary transfer roller 57 is shown in FIG. 3.

In the transport path 53, at a position further downstream side than the secondary transfer roller 57, a heat roller 59 for heat fixing and a press roller 60 which is in contact with the heat roller 59 are disposed. At the end of the transport path 53, a paper discharge roller 61 is disposed. A transport path 62 for reversing the front and rear sides of the paper sheet P is disposed from the end of the transport path 53 to a position on the upstream side of the registration roller 58. Paper feed rollers 63, 64, and 65 are disposed on the transport path 62. As the paper sheet P that reaches the end of the transport path 53 is returned to the transport path 53 through the transport path 62, the visible image on the transfer belt 25 is secondarily transferred onto the rear side of the paper sheet P.

On the other hand, at a position opposing the drive roller 26, a first blade 36 which is made of rubber and for cleaning is disposed with the transfer belt 25 interposed therebetween along the width direction of the transfer belt 25. The length of the first blade 36 is equal to or greater than the width of the transfer belt 25. The first blade 36 comes in contact with the surface of the transfer belt 25 and scrapes off the developer remaining on the surface of the transfer belt 25.

A second blade 70 which is made of rubber and for cleaning is disposed along the axial direction of the second transfer roller 57 while being in contact with the surface of the second transfer roller 57. The length of the second blade 70 is equal to or greater than the axial length of the second transfer roller 57. The second blade 70 scrapes off the developer remaining on the surface of the second transfer roller 57 by coming in contact with the surface of the second transfer roller 57.

A bar-shaped lubricant, for example, a metal soap 71 is disposed below the second transfer roller 57 along the axial direction of the secondary transfer roller 57. The length of the metal soap 71 is equal to or greater than the axial length of the secondary transfer roller 57. As the metal soap 71, for example, zinc stearate Zn-St is used.

A brush roller 72 which uses a fur brush is disposed between the secondary transfer roller 57 and the metal soap 71 along the axial direction of the secondary transfer roller 57. The axial length of the brush roller 72 is equal to or greater than the axial length of the secondary transfer roller 57. The brush roller 72 rotates while coming in contact with the secondary transfer roller 57 and the metal soap 71, thereby applying a component of the metal soap 71 to the surface of the secondary transfer roller 57.

A plurality of bases 73a and 73b which are made of metal, for example, a sheet metal are disposed at intervals along the axial direction of the secondary transfer roller 57. The interval between the bases 73a and 73b is, for example, smaller than 8 mm. The top surfaces of the bases 73a and 73b are flat surfaces having the same height position. The metal soap 71 is attached to the flat surfaces using, for example, a double-sided tape. The bases 73a and 73b hold the metal soap 71 in a state where the surface of the metal soap 71 comes in contact with tips of the brush roller 72.

A plurality of springs 74 are disposed between the lower surfaces of the bases 73a and 73b and a fixed substrate 75. The springs 74 exert biasing forces on the bases 73a and 73b so that the surface of the metal soap 71 comes in pressing contact with the tips of the brush roller 72.

As the brush roller 72 is rotated, the component of the metal soap 71 is scraped away and applied to the secondary transfer roller 57. By the application, lubricating properties of contact portions of the secondary transfer roller 57 and the second blade 70 are enhanced. Since the lubricating properties are enhanced, the life-span of the secondary transfer roller 57 is increased, and peeling of the second blade 70 or chipping of edges thereof can be prevented.

When there is no paper sheet S between the transfer belt 25 and the secondary transfer roller 57, the component applied to the secondary transfer roller 57 is transferred to the surface of the transfer belt 25. By the transfer, lubricating properties of the contact portions of the transfer belt 25 and the first blade 36 are enhanced. Since the lubricating properties are enhanced, the life-span of the transfer belt 25 is increased, and peeling of the first blade 36 or chipping of edges thereof can be prevented.

Experimental results of the thermal expansion of the metal soap 71 and thermal expansion of the bases 73a and 73b are shown in FIG. 5. The coefficient of thermal expansion of the metal soap 71 is high, and the coefficient of thermal expansion of the bases 73a and 73b is low. Accordingly, if the metal soap 71 is attached to a single base, there is a concern that cracking or peeling of the metal soap 71 may occur when the ambient temperature is changed.

Here, in this embodiment, the two bases 73a and 73b which are disposed at intervals along the axial direction of the secondary transfer roller 57 are used. When the bases 73a and 73b undergo thermal expansion and extend in the axial direction of the secondary transfer roller 57, the extension is absorbed by the gap between the bases 73a and 73b. Due to the absorption of the extension, a problem of exerting unnecessary force on the metal soap 71 can be solved as much as possible. Therefore, cracking or peeling of the metal soap 71 does not occur.

In an experiment in which the bases 73a and 73b and the metal soap 71 were left in an environment of −30° C. for 7 hours, and were moved to an environment of 60° C. and then left for 7 hours, cracking or peeling of the metal soap 71 did not occur.

Incidentally, in the embodiment, the two bases 73a and 73b are used, however, three bases 73a, 73b, and 73c which are disposed at intervals along the axial direction of the secondary transfer roller 57 may also be used as shown in FIG. 6.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An image forming apparatus comprising:
an image holding body on which a developer image is formed;
a transfer roller which rotates while coming in contact with a surface of the image holding body, and rotates with a recording medium interposed between the image holding body and the transfer roller, thereby transferring the developer image on the image holding body onto the recording medium;
a blade which cleans the developer remaining on the surface of the image holding body or a surface of the transfer roller by coming in contact with the surface of the image holding body or the surface of the transfer roller;
a lubricant having a bar shape along an axial direction of the transfer roller;
a brush roller which rotates while coming in contact with the transfer roller and the lubricant, thereby applying a component of the lubricant to the surface of the transfer roller; and
a plurality of bases which are made of metal and are disposed at intervals along the axial direction of the transfer roller, and which holds the lubricant in a state where the lubricant comes in contact with the brush roller.

2. The apparatus according to claim 1, further comprising a plurality of springs that exert a biasing force on each of the bases so that the lubricant comes in pressing contact with the brush roller.

3. The apparatus according to claim 1, wherein the lubricant is a metal soap.

4. The apparatus according to claim 1, wherein the blade includes a first blade which is made of rubber and cleans the developer remaining on the surface of the image holding body by coming in contact with the surface of the image holding body, and a second blade which is made of rubber and cleans the developer remaining on the surface of the transfer roller by coming in contact with the surface of the transfer roller.

5. The apparatus according to claim 1, wherein the image holding body includes a photoconductive drum for yellow, a photoconductive drum for magenta, a photoconductive drum for cyan, a photoconductive drum for black, and a transfer belt that rotates while coming in contact with surfaces of the photoconductive drums.

6. The apparatus according to claim 5, wherein the transfer roller rotates while coming in contact with the surface of the transfer belt, and rotates with a recording medium interposed between the transfer belt and the transfer roller, thereby transferring the developer image on the transfer belt onto the recording medium.

7. The apparatus according to claim 6, wherein the blade includes a first blade which is made of rubber and cleans the developer remaining on the surface of the transfer belt by coming in contact with the surface of the transfer belt, and a second blade which is made of rubber and cleans the developer remaining on the surface of the transfer roller by coming in contact with the surface of the transfer roller.

8. The apparatus according to claim 7,
wherein the first blade scrapes off the developer remaining on the surface of the transfer belt, and
the second blade scrapes off the developer remaining on the surface of the transfer roller.

9. The apparatus according to claim 1, wherein each base is made of a sheet metal and has a flat surface for attaching the lubricant.

10. An image forming apparatus comprising:
a plurality of photoconductive drums;
an exposure unit which forms a latent image on a surface of each photoconductive drum by exposing the surface of each photoconductive drum;
a plurality of developing units which develop the latent images formed on the surfaces of the photoconductive drums into visible images using a developer;
a transfer belt which rotates while coming in contact with the surface of each photoconductive drum;
a plurality of primary transfer rollers which primarily transfer the visible image on each photoconductive drum onto a surface of the transfer belt by causing the transfer belt to come in pressing contact with the surface of each photoconductive drum;
a secondary transfer roller which rotates while coming in contact with the surface of the transfer belt, and rotates with a recording medium interposed between the transfer belt and the secondary transfer roller, thereby secondarily transferring the visible image primarily transferred on the transfer belt onto the recording medium;
a first blade which cleans the developer remaining on the surface of the transfer belt by coming in contact with the surface of the transfer belt;
a second blade which cleans the developer remaining on the surface of the transfer roller by coming in contact with the surface of the transfer roller;
a lubricant having a bar shape along an axial direction of the secondary transfer roller;
a brush roller which rotates while coming in contact with the secondary transfer roller and the lubricant, thereby applying a component of the lubricant to the surface of the secondary transfer roller; and
a plurality of bases which are made of metal and are disposed at intervals along the axial direction of the secondary transfer roller, and which holds the lubricant in a state where the lubricant comes in contact with the brush roller.

11. The apparatus according to claim 10, further comprising a plurality of springs that exert a biasing force on each of the bases so that the lubricant comes in pressing contact with the brush roller.

12. The apparatus according to claim 10, wherein the lubricant is a metal soap.

13. The apparatus according to claim 10, wherein the photoconductive drums are a photoconductive drum for yellow, a photoconductive drum for magenta, a photoconductive drum for cyan, and a photoconductive drum for black.

14. The apparatus according to claim 10,
wherein the first blade scrapes off the developer remaining on the surface of the transfer belt, and
the second blade scrapes off the developer remaining on the surface of the transfer roller.

15. The apparatus according to claim 10, wherein each base is made of a sheet metal and has a flat surface for attaching the lubricant.
